(19) United States
(12) Patent Application Publication
(10) Pub. No.: US 2022/0063254 A1
(43) Pub. Date: Mar. 3, 2022

(54) CONTAINER COMPRISING LAMINATE OF POLYETHYLENE

(71) Applicant: The Procter & Gamble Company, Cincinnati, OH (US)

(72) Inventors: Zhan CHENG, Beijing (CN); Lei ZHOU, Beijing (CN); Jiashao RONG, Beijing (CN); Dong YAN, Beijing (CN)

(21) Appl. No.: 17/465,057

(22) Filed: Sep. 2, 2021

(30) Foreign Application Priority Data
Sep. 3, 2020 (WO) CN2020/113202
Mar. 21, 2021 (WO) CN2021/084465

(51) Int. Cl. B32B 27/32; B32B 27/08

(52) U.S. Cl. CPC B32B 27/32; B32B 27/08; B32B 2307/31; B32B 2307/732; B32B 2307/54; B32B 2439/46; B32B 2307/518

(57) ABSTRACT

A container including a laminate is provided, wherein the laminate includes a first layer of machine direction oriented polyethylene (MDO-PE), a second layer of biaxial oriented polyethylene (BO-PE), and a third layer of polyethylene (PE).

### FIELD OF THE INVENTION

The present application is directed to a container comprising a laminate of polyethylene.

### BACKGROUND OF THE INVENTION

Plastic packaging including rigid bottles and flexible bags (also called pouches herein) are widely used in a variety of applications. One of the most important requirements for plastic packaging, especially for heavy duty plastic packaging for products such as detergent powders or liquids, is the mechanical strength of the thermoplastic material that is employed to prepare the plastic packaging, because the plastic packaging needs to resist impact to some extents and maintain packaging integrity till the end of the product usage In order to assess whether the plastic packaging is robust enough to contain the content therein, some tests are employed to measure mechanical performances. The most common tests include tensile strength, sealing strength and drop test. The test for tensile strength is to measure how much tensile stress to make the plastic film break. The test for sealing strength is to measure how much tensile stress to make the plastic packaging (such as a flexible bag) sealing break. The drop test is to measure the holistic robustness of the plastic packaging, in which the plastic packaging is dropped from a certain height and then check if any leakage happens.

Particularly, Stand Up Pouch (SUP) with bottom gusset feature is one of the most widely used flexible packages due to its standup ability and improved usage experiences, and is typically used for containing powders or liquids for products such as in the area of fabric care. Such pouches has very high mechanical performance requirements to prevent leakage due to dropping from a height or stocks by other objects throughout the entire product life cycle. In this case, the selection of the thermoplastic material that is employed to prepare such plastic packaging is very limited, because most of thermoplastic materials cannot provide sufficient mechanical strength as required. Further, in order to meet the requirements for mechanical strength, a laminate comprising two or more layers of thermoplastic materials is commonly employed. Currently, the commercially available laminate which can pass the drop test for detergent pouches includes polyethylene terephthalate/polyethylene (PET/PE) laminate, polyamide/polyethylene (PA/PE) laminate, PET/PA/PE laminate, and PET/Vacuum metalized PET/PE laminate. However, none of these laminates are recyclable, because all of them comprise at least two different thermoplastic polymers. Thus, there is a need to develop a laminate which has sufficient mechanical strength and also is recyclable.

Polyethylene (PE) is a common thermoplastic polymer for plastic packaging. However, PE films are in general of lower mechanical strength and heat resistance compared to other thermoplastic polymer films such as PET and PA. Recently, some new types of PE films such as oriented PE films have been developed to improve the mechanical property of PE films. However, there is no known pouches made of mono-polymer PE laminate can pass the drop test especially under heavy load above 1 kg for liquid products prior to the present invention. Thus, the plastic packaging such as Stand Up Pouch (SUP) made of mono-polymer PE laminates is still technically challenging in the term of heavy duty applications for liquids (especially the drop test).

### SUMMARY OF THE INVENTION

The present disclosure meets one or more of the above-mentioned needs based on the surprising discovery that a mono-polymer PE laminate comprising a first layer of machine direction oriented polyethylene (MDO-PE), a second layer of biaxial oriented polyethylene (BO-PE), and a third layer of polyethylene (PE) can provide sufficient mechanical strength, especially is capable of passing the drop test. Further, the laminate according to the present disclosure may be recyclable because the laminate is a mono-polymer PE laminate, i.e. the principle thermoplastic polymer in the laminate is PE.

In one aspect, the present disclosure provides a container comprising a laminate in which the laminate comprises a first layer of MDO-PE, a second layer of BO-PE, and a third layer of PE.

In another aspect, the present disclosure provides a laundry detergent bag containing from 0.1 kg to 3 kg of laundry detergent, wherein the bag is constructed from a laminate comprising a first layer of MDO-PE, a second layer of BO-PE, and a third layer of PE.

In a further aspect, the present disclosure provides a laminate comprising a first layer of MDO-PE, a second layer of BO-PE, and a third layer of PE.

It is an advantage of the laminate to have sufficient mechanical strength to prevent leakage due to dropping from a height, stocking contents or stabbing by sharp objects.

It is another advantage of the laminate to be capable of passing the drop test for detergent stand-up bags.

It is another advantage of the laminate to be capable of making a container for detergent powders or liquids that is recyclable.

It is another advantage of the laminate to allow a sufficient heat-sealing between two laminates according to the present disclosure.

These and other features, aspects and advantages of specific embodiments will become evident to those skilled in the art from a reading of the present disclosure.

### BRIEF DESCRIPTION OF THE DRAWINGS

The embodiments set forth in the drawings are illustrative in nature and not intended to limit the invention defined by the claims. The following detailed description of the illustrative embodiments can be understood when read in conjunction with the following drawings, and in which:

FIG. 1 illustrates an embodiment of the laminate according to the present disclosure.

FIG. 2 illustrates another embodiment of the laminate according to the present disclosure.

### DETAILED DESCRIPTION OF THE INVENTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

The present disclosure is directed to a container comprising a laminate in which the laminate comprises a first layer of MDO-PE, a second layer of BO-PE, and a third layer of PE. The total thickness of the laminate according to the present disclosure may be from 70 microns to 400 microns, preferably from 100 microns to 350 microns, more preferably from 120 microns to 300 microns, most preferably from 140 microns to 250 microns. Particularly, the first layer may have a thickness of from 5 microns to 50 microns, preferably from 10 microns to 45 microns, more preferably from 15 microns to 40 microns, most preferably from 20 microns to 30 microns; and/or the second layer may have a thickness of from 5 microns to 50 microns, preferably from 8 microns to 45 microns, more preferably from 12 microns to 40 microns, most preferably from 15 microns to 25 microns; and/or the third layer may have a thickness of from 10 microns to 250 microns, preferably from 30 microns to 230 microns, more preferably from 100 microns to 200 microns, most preferably from 120 microns to 160 microns.

Preferably, the container may be recyclable. More preferably, the laminate according to the present disclosure may comprise no more than 10% by weight, preferably no more than 7%, more preferably no more than 5%, most preferably no more than 3%, of thermoplastic polymer that is not PE.

Preferably, the laminate according to the present disclosure may have a tensile strength along the machine direction as measured by the method according to Test 2 of more than 100 N/inch, preferably more than 120 N/inch, more preferably more than 130 N/inch, most preferably more than 140 N/inch.

Preferably, the laminate according to the present disclosure may have a tensile strength along the transverse direction as measured by the method according to Test 2 of more than 100 N/inch, preferably more than 120 N/inch, more preferably more than 130 N/inch, most preferably more than 140 N/inch; and/or

Preferably, the laminate according to the present disclosure may have a sealing strength at the side seal as measured by the method according to Test 3 of more than 70 N/inch, preferably more than 80 N/inch, more preferably more than 90 N/inch, most preferably more than 100 N/inch; and/or

Preferably, the laminate according to the present disclosure may have a sealing strength at the bottom seal as measured by the method according to Test 3 of more than 70 N/inch, preferably more than 80 N/inch, more preferably more than 90 N/inch, most preferably more than 100 N/inch.

Preferably, the container according to the present disclosure may be a flexible bag (also called “pouch”), preferably a flexible stand-up bag. The term of “stand-up bag”, “Stand Up Bag” or “Stand Up Pouch” used herein refers to a bag having a bottom gusset feature which is capable of allowing the bag to stand up without being supported by any external articles. Particularly, the container according to the present disclosure may be a flexible bag with a spout, preferably a flexible stand-up bag with a spout.

The term “spout” as used herein covers a spout assembly with or without a cap, and particularly, a spout comprises a spout body and a cap that is preferably separable from the spout body. The spout may have any suitable sizes, for example having a diameter of from 0.5 cm to 10 cm. The spout may be located at any appropriate location, and particularly, the spout may be located on the top edge, for example near a midpoint of the top edge (i.e., top-spout pouches), or near a connection point between the top edge and the first side edge (i.e., corner-spout pouches). The spout may have a centroid. The spout may have one or more features. The term “feature” as used herein means any structural characteristics. The spout can be fabricated via suitable processes, for example injection molding, compression molding, and blow molding, etc. And the spout may be made from polyolefins for examples PE or PP, preferably HDPE and more preferably blends of HDPE and LLDPE.

Preferably, the container may contain from 0.05 kg to 10 kg, preferably 0.1 kg to 5 kg, more preferably 0.2 kg to 3 kg of product, for example 0.1 kg, 0.2 kg, 0.3 kg, 0.4 kg, 0.5 kg, 1 kg, 2 kg, 3 kg, 4 kg, 5 kg or any ranges thereof. More preferably, the product may be selected from the group consisting of fabric care products, home care products, hair care products, beauty care products, and personal care products, preferably a laundry detergent product, more preferably a granule laundry detergent or a liquid laundry detergent.

The layers in the laminate according to the present disclosure may be arranged in any sequence. Preferably, the layers in the laminate according to the present disclosure may be arranged as being i), ii), and iii) or ii), i) and iii) in turn from outside to inside. In the context of the present disclosure, the term “inside” refers to a side of the laminate in the packaging (e.g. a flexible bag) which is facing to the content (e.g. detergent liquids) contained in the packaging and the term “outside” refers to a side of the laminate that is opposite to the inside.

The entire laminate and layers in the laminate according to the present disclosure may have different initial sealing temperatures as measured by the method according to Test 4. Particularly, the entire laminate according to the present disclosure may have an initial sealing temperature of no more than 125° C., preferably no more than 120° C., more preferably no more than 118° C., most preferably no more than 115° C., as measured by the method according to Test 4, and the first layer may have an initial sealing temperature of at least 130° C., preferably at least 135° C., more preferably at least 140° C., most preferably at least 145° C., as measured by the method according to Test 4.

In another aspect, the present disclosure provides a bag containing from 0.05 kg to 10 kg, preferably 0.1 kg to 5 kg, more preferably 0.2 kg to 3 kg of laundry detergent, wherein the bag is constructed from a laminate comprising a first layer of MDO-PE, a second layer of BO-PE, and a third layer of PE.

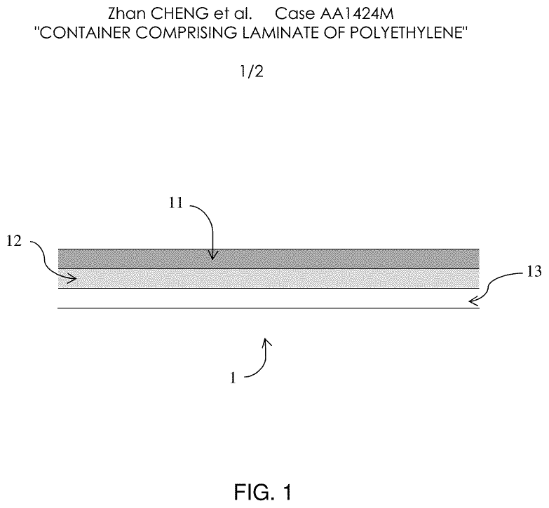

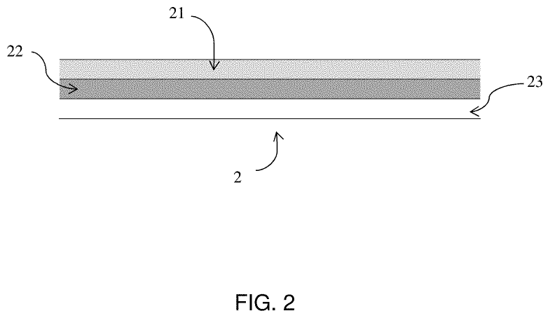

In a further aspect, the present disclosure provides a laminate comprising a first layer of MDO-PE, a second layer of BO-PE, and a third layer of PE. FIGS. 1 and 2 illustrate embodiments of laminates according to the present disclosure.

FIG. 1 illustrates a laminate 1 comprising a first layer 11 of MDO-PE, a second layer 12 of BO-PE, and a third layer 13 of PE, in which adhesive between layers are not shown.

FIG. 2 illustrates a laminate 2 comprising a first layer 2 of BO-PE, a second layer 22 of MDO-PE, and a third layer 23 of PE, in which adhesive between layers are not shown.

Polyethylene (“PE”)

The laminate of the present disclosure comprises polyethylene (PE) as a principle thermoplastic polymer (i.e., a PE-based laminate). In turn, the PE component may comprise one or more divisions (or even sub-divisions) of PE polymers. PE is generally divided into high-density (HDPE, density 0.941 g/cc or greater), medium-density (MDPE, density from 0.926 to 0.940 g/cc), low-density (LDPE, density from 0.910 to 0.925 g/cc), and linear low-density polyethylene (LLDPE, density from 0.910 to 0.925 g/cc). See e.g., ASTM D4976-98: Standard Specification for Polyethylene Plastic Molding and Extrusion Materials. In turn, these PE divisions can be further divided into mono-modal or multi-modal (e.g., bi-modal) sub-divisions.

One of the main uses of polyethylene (HDPE, LLDPE, and LDPE) is in film applications, such as grocery sacks, institutional and consumer can liners, merchandise bags, shipping sacks, food packaging films, multi-wall bag, liners, produce bags, stretch wraps, shrink wraps, and the like. The key physical properties of PE-based film layer may include tear strength, impact strength, tensile strength, stiffness, and transparency. Different combinations of PE divisions, and sub-divisions be used herein depending upon the application and/or desired film property. In some embodiments, the PE component in the laminate of the present disclosure, will comprise some level of a linear low density polyethylene (LLDPE) polymer.

At least one layer of the film comprises 70% to 99%, by weight of the at least one layer of the film of a PE component. Preferably the at least one layer of the film comprises from 75% to 98%, more preferably 80% to 95%, yet more preferably 82% to 93%, by weight of the at least one layer, of the PE component. The PE component has at least one PE polymer, optionally two or more PE polymers. At least one layer of the film comprises from 70% to 99%, by weight of the at least one layer, of at least one PE polymer of the PE component. Preferably the at least one layer of film comprises from 75% to 98%, more preferably 80% to 95%, yet more preferably 82% to 93%, by weight of the at least one layer, of the at least one PE polymer of the PE component.

In some embodiments, the at least one film layer comprises from 1% to 100% by weight of the PE component, of a LLDPE polymer. More preferably the LLDPE is from 25% to 100%, alternatively from 25% to 90%, yet more preferably from 30% to 100%, yet more preferably the LLDPE is greater than 50%, preferably greater than at least 60%, more preferably greater than at least 70%, by weight of the PE component (in the at least one film layer).

In some embodiments, the at least one film layer comprises from 1% to 100% by weight of the PE component, of a HDPE or MDPE polymer. More preferably the HDPE or MDPE is from 10% to 80%, alternatively from 20% to 60%, yet more preferably from 30% to 50% by weight of the PE component (in the at least one film layer).

Suitable suppliers/products for PE may include Dowlex™ from Dow Chemical, and Borstar™ from Borealis and Borouge and Enable™ from Exxon Mobile

Machine Direction Oriented Polyethylene (MDO-PE)

The laminate of the present disclosure comprises a layer of machine direction oriented polyethylene (MDO-PE). The machine direction (MD) is also known as the longitudinal direction (generally perpendicular to the traverse direction (TD)). MD orientating is a preferred initial step after an unconverted film is formed. During the MD orientation, the unconverted film from the blown or casted line is heated to an orientation temperature via one or multiple hot rollers. The heated film is fed into a slow draw roll with a nip roller, which has the same rolling speed as the heating rollers. The film then enters a fast draw roll. The fast draw roll has a speed that is 2 to 10 times faster than the slow draw roll, which effectively stretches the film on a continuous basis. There can be another fast draw roll which is even faster than the first fast draw roll so that the film is subjected to two step stretching. Between the two stretching steps there is another set of heating rolls which sets the temperature of the film after the first stretching and before the second stretching. The temperatures in these two stretching steps can be the same or different. The orientation can also be a single stretching instead of two step stretching.

The total MD stretch ratio is from 2:1 to 10:1, more preferably from 3:1 to 9:1, and even more preferably from 5:1 to 8:1. The total MD stretch ratio includes all orientation steps. For example, if a two-step orientation is used with first stretch ratio 2:1 and second stretch ratio 3:1, the total stretch ratio is therefore 6:1.

The orientation temperature in a MD orientation, is around 50° C. to below 140° C., preferably below 130° C., more preferably below 120° C., alternatively 60° C. to 120° C., or below 115° C., or from 70° C. to 115° C. The temperature also depends on the process speed. In general, higher process speed requires relatively higher temperature due to the relative shorter contacting time between film and hot rollers; while slower process speed requires relatively lower temperature due to the longer contacting time.

A typical thickness of the MDO-PE layer is from 5 microns to 50 microns, preferably from 10 microns to 45 microns, more preferably from 15 microns to 40 microns, most preferably from 20 microns to 30 microns.

Biaxial Oriented Polyethylene (BO-PE)

The laminate of the present disclosure comprises a layer of biaxial oriented polyethylene (BO-PE). BO-PE film is a film stretched in both MD and TD, resulting in molecular chain orientation in two directions. One of the common processes for preparing BO-PE is the sequential process, in which a thick extruded sheet is heated to its softening point (not to the melting point) and is mechanically drawn in the machine direction using heated rollers and subsequently drawn in the transverse direction, i.e. orthogonally to the direction of travel, in a heated oven. It is also possible to draw the film in both directions simultaneously, although the equipment required for this is somewhat more elaborate. Particularly, BO-PE may be produced by a tubular process, in which a tubular bubble is inflated, or a tenter frame process, in which a thick extruded sheet is heated to its softening point (not to the melting point) and is mechanically stretched. Biaxial oriented polyethylene film process has been disclosed in patents WO201270373A1, U.S. Pat. Nos. 10,363,700B2, and 6,689,857B1 as examples.

The MD stretch ratio may be from 4.5:1 to 6:1, and the TD stretch ratio may be from 7:1 to 8:1, although these ratios are fully adjustable.

A typical thickness of the BO-PE layer is from 5 microns to 50 microns, preferably from 8 microns to 45 microns, more preferably from 12 microns to 40 microns, most preferably from 20 microns to 40 microns.

### Test Method

### Test 1. Drop Test

The drop test conducted in the present disclosure is based on Neyer drop test as follows.

30 pcs filled pouches are subject to a free-fall experiment from a height ranging from 73.9 cm to 182 cm. Particularly, every single pouch is dropped for 4-5 times (2× base, 1× front, 1× back, 1× spout if have to face downward during dropping) from the height of 73.9 cm to see if it can pass (no leakage) or fails. If it can pass at the height of 73.9 cm, then the free-fall experiment will be repeated from an increased height until the height of 182 cm or it fails at some height. The tolerable height is calculated by the average of maximum height minus 3 standard deviation for total 30 pcs as an outcome. Success criteria is the tolerable height >/=1.0 meter. Testing condition is room temperature (25° C.).

### Test 2. Tensile Strength Test

The tensile strength is measured on an Instron tensile tester under room temperature along both the machine direction and the transverse direction. The samples are obtained by cutting the body or the bottom of pouches into film strips having a width of 25.4 mm and a length of 250 mm Tensile tester (cross head) moving speed is 300 mm/min. The breaking force for each film strip is recorded as the outcome, i.e., the tensile strength along the machine direction and the tensile strength along the transverse direction.

### Test 3. Seal Strength Test

The seal strength is also measured on an Instron tensile tester under room temperature. The samples are obtained by cutting the sealed laminates at different locations of the pouch into film strips having a width of 25.4 mm For the side seal, the samples are obtained at 6 different locations (3 for left and 3 for right), and for the bottom seal, the samples are obtained at 6 different locations (3 for front and 3 for back). Tensile tester (cross head) moving speed is 300 mm/min. The average of separation forces for film strips from both different locations of the side seal and different locations of the bottom seal are recorded as the outcome, i.e., the seal strength of the side seal and the seal strength of the bottom seal.

### Test 4. Measurements of Initial Sealing Temperature

The initial sealing temperature is measured on a hot tack equipment (SL-10 from Testing Machines Inc., New Castle—Del., USA) which can precisely control the temperature, time and pressure of heat seal by setting the control panel. The samples are heated on the equipment under 4 bar, 0.72 s by using different temperatures (starting from a relatively low temperature) to determine if it can be sealed. If it cannot be sealed, the test is repeated at a higher temperature. The minimum temperature interval for this equipment can be 1° C. If the sample can be sealed starting from a certain temperature, such temperature is recorded as the initial sealing temperature.

### EXAMPLES

### Example 1

### Drop Test for Stand Up Pouches with Mono-Polymer PE Laminates

Pouches were made respectively using different mono-polymer PE laminates in which Laminate 1 had a 3-layer structure (MDO-PE, BO-PE and PE) and Comparative Laminates 1 and 2 had a 2-layer structure (MDO-PE and PE for Comparative Laminate 1 and BO-PE and PE for Comparative Laminate 2). Each laminate was prepared by dry lamination, in which an adhesive was applied on one layer of film, dried and then put another layer of film onto the adhesive surface to form bond. In case of 3-layer structure, the same process was applied again between a third layer of film and the 2-layer laminate. The specific structures of Laminate 1 and Comparative Laminate 1 and 2 are shown in the following Table 1. The initial sealing temperatures for MDO-PE, BO-PE and PE as measured by the method according to Test 4 are >155° C., 125° C. and 125° C., respectively.

Stand Up Pouches (SUPs) were made by using Laminate 1 and Comparative Laminates 1 and 2. The SUP comprised three panels which were front panel, back panel and bottom panel. The pouch making process included film slitting, body panels (front panel and back panel) two-side sealing, bottom panel two-side sealing, Gusset part four-side sealing, and Gusset punching. Particularly, the bottom panel was a rectangle which could be folded at the centerline horizontally. The two edges of the bottom panel along the longer side were sealed with the front and back panels respectively. At the gusset part, the body panels two-side sealing and the gusset part four-side sealing were formed simultaneously. The SUP was made by using Tiemin pouch making machine from Tiemin, Wuxi, China (sealing temperatures: 125 to 130° C. and sealing pressures: 3 to 4 bar).

The pouches made of Laminate 1 as well as Comparative Laminate 1 and 2 had the identical design, i.e., the design of the pouch for Ariel Japan, 1.35 kg heavy detergent liquid (pouch dimension was Width 198 mm, Height 272 mm, Gusset Depth 55 mm). The MDO-PE and BO-PE film used in all these laminates were identical. The blown PE used across all these laminates were with identical PE composite and only varies in the thickness. Pouches for all these three laminates were formed on the same pouch making machine. Pouches were successfully prepared by using Laminate 1 and Comparative Laminate 1, but Pouches were failed to be made by using Comparative Laminate 2 because the pouches could not be heat-sealed without sealing problems Particularly, the pouches for Comparative Laminate 2 were either not well sealed leaving weak or open seals, or over sealed with significantly wrinkled or burnt seals. No operational window was found on the pouch making machine. Water was filled with target filling weight of 1.36 kg.

TABLE 1
Structures of mono-polymer PE laminates

| | Laminate 1 | Comparative Laminate 1 | Comparative Laminate 2 |
|---|---|---|---|
| Outer layer | MDO-PE¹, 25 μm | MDO-PE, 25 μm | BO-PE, 20 μm |
| Middle layer | BO-PE², 20 μm | — | — |
| Inner layer | Blown PE³, 140 μm | Blown PE⁴, 170 μm | Blown PE, 170 μm |
| Total thickness | ~185 to 190 μm⁵ | ~195 to 200 μm | ~190 to 195 μm |

¹MDO-PE from Huangshan Novel Co., Ltd., Huangshan, Anhui, China
²BO-PE from Guangdong Decro Film New Materials co., ltd., Foshan, Guangdong, China
³Blown PE from Huangshan Novel Co., Ltd., Huangshan, Anhui, China
⁴Blown PE from Huangshan Novel Co., Ltd., Huangshan, Anhui, China
⁵The total thickness comprises thickness of all PE layers and thickness of adhesive between PE layers.

The drop test was conducted according to Test 1. 30 pcs of pouches prepared as above were subject to the drop test under room temperature. The tolerable height was calculated by the average of maximum height minus 3 standard deviation for total 30 pcs. The results of the drop test are shown in Table 2 below, in which Laminate 1 shows significant better drop resistance than Comparative Laminate 1, although Laminate 1 has a thinner total thickness than Comparative Laminate 1.

TABLE 2
Results of the drop test

| | Tolerable height | | Note |
|---|---|---|---|
| Laminate 1 | >182.0 | cm | 21 pcs passed 182.0 cm |
| Comparative Laminate 1 | 83.4 | cm | 0 pcs passed 182.0 cm |

### Example 2

### Improved Tensile Strength of 3-Layer Mono-Polymer PE Laminates Compared to 2-Layer Mono-Polymer PE Laminates

Laminate 1 and Comparative Laminate 1 were subject to the tensile strength test according to Test 2. The results of the tensile strength test are shown in Table 3 below in which Laminate 1 shows significant improved tensile strength especially in transverse direction compared to Comparative Laminate 1, although Laminate 1 has a thinner total thickness than Comparative Laminate 1.

TABLE 3
Results of the tensile strength test

| | Machine direction | Transverse direction |
|---|---|---|
| | (N/inch) | (N/inch) |
| Laminate 1 | 178.87 | 167.06 |
| Comparative | 175.46 | 128.00 |
| Laminate 1 | | |

### Example 3

### Improved Sealing Strength of 3-Layer Mono-Polymer PE Laminates Compared to 2-Layer Mono-Polymer PE Laminates

Samples were taken from different locations including at least three locations at bottom and at least three locations at side of the stand-up bags prepared in Example 1, and then subject to the sealing strength test according to Test 3. The results of the sealing strength test are shown in Table 4 below in which Laminate 1 shows much higher sealing strength for bottom seal of the stand-up bags compared to Comparative Laminate 1, although Laminate 1 has a thinner total thickness than Comparative Laminate 1.

TABLE 4
Results of the sealing strength test

| | Side seal (N/inch) | Bottom seal (N/inch) |
|---|---|---|
| Laminate 1 | 115.2 | 130.7 |
| Comparative Laminate 1 | 124.9 | 62.0 |

### Example 4

### Successful Making of Spouted Stand-Up Pouches with Mono-Polymer PE Laminates

Similarly as in Example 1, stand-up pouches were made respectively using different mono-polymer PE laminates (Laminate 1 and Comparative Laminate 1) except that the stand-up pouch contains a spout at a connection point between the top edge and the side edge of the pouch. The spout was made of PE. During the manufacturing of the pouches, the spout was inserted in a continuous spout insertion machine (Totani ST-30 Spout Insertion Machine). Particularly, the spout was pre-heated (e.g. 200-240° C., 0.35 MPa and 0.5 second). Then, the spout was heat-sealed at heating station #1 (e.g. 165° C., 0.2 MPa and 0.2 second) and subsequently heat-sealed at heating station #2 (e.g. 190° C., 0.1 MPa and 0.1 second). Finally, it was cooled at cooling station (0.35 MPa and 0.35 second).

As shown in Table 5 below, Laminate 1 had a 3-layer structure (MDO-PE, BO-PE and PE) and Comparative Laminates 1 had a 2-layer structure (MDO-PE and PE for Comparative Laminate 1). Each laminate was prepared similarly as in Example 1.

TABLE 5
Structures of mono-polymer PE laminates

| | Laminate 1 | Comparative Laminate 1 |
|---|---|---|
| Outer layer | MDO-PE¹, 25 μm | MDO-PE, 25 μm |
| Middle layer | BO-PE², 20 μm | — |
| Inner layer | Blown PE³, 140 μm | Blown PE⁴, 170 μm |
| Total thickness | ~185 to 190 μm⁵ | ~195 to 200 μm |

¹MDO-PE from Huangshan Novel Co., Ltd., Huangshan, Anhui, China
²BO-PE from Guangdong Decro Film New Materials co., ltd., Foshan, Guangdong, China
³Blown PE from Huangshan Novel Co., Ltd., Huangshan, Anhui, China
⁴Blown PE from Huangshan Novel Co., Ltd., Huangshan, Anhui, China
⁵The total thickness comprises thickness of all PE layers and thickness of adhesive between PE layers.

The spouted stand-up pouches made of Laminate 1 and Comparative Laminate 1 had the identical design, i.e., the design of the spouted-pouch for Ariel Japan, 1.35 kg heavy duty liquid (pouch dimension was Width 198 mm, Height 272 mm, Gusset Depth 55 mm). The MDO-PE film used in all these laminates were identical. The blown PE used across all these laminates were with identical PE composite and only varies in the thickness. Pouches for all these three laminates were formed on the same pouch making machine. Pouches were successfully prepared by using Laminate 1, but pouches were failed to be made by using Comparative Laminate 1 because the spout could not be heat-sealed with the laminate without sealing problems. The results of pouch making are shown below. Further, some other sealing conditions were tried for Comparative Laminate 1, but all failed.

TABLE 6
Results of the pouch making

| | Laminate 1 | Comparative Laminate 1 |
|---|---|---|
| Conditions: | Success | Failed |
| Pre-heated: | | (Burnt at spout area) |
| 240° C., 0.35 MPa and 0.35 second | | |
| Heat-sealing #1: | | |
| 220° C., 0.2 MPa and 0.2 second | | |
| Heat-sealing #2: | | |
| 220° C., 0.2 MPa and 0.2 second | | |
| Cooling: 0.35 MPa and 0.35 second | | |

### Example 5

### Drop Test for Spouted Stand-Up Pouches with Mono-Polymer PE Laminates

In order to determine if the spouted stand-up pouches made of mono-polymer PE laminates can pass the drop test, Laminates 2 and 3 as shown in Table 7 below were used to prepare the spouted-pouch for Ariel Japan, 1.35 kg heavy duty liquid (pouch dimension was Width 198 mm, Height 272 mm, Gusset Depth 55 mm) and the spouted-pouch for Ariel Japan, 500 g heavy detergent liquid (pouch dimension was Width 140 mm, Height 225 mm, Gusset Depth 38 mm), similarly as in Example 4.

TABLE 7
Structures of mono-polymer PE laminates

| | Laminate 2 | Laminate 3 |
|---|---|---|
| Outer layer | MDO-PE¹, 25 μm | MDO-PE¹, 25 μm |
| Middle layer | BO-PE², 25 μm | BO-PE², 40 μm |
| Inner layer | Blown PE³, 140 μm | Blown PE³, 140 μm |
| Total thickness | ~190 to 195 μm⁴ | ~205 to 210 μm |

¹MDO-PE from Huangshan Novel Co., Ltd., Huangshan, Anhui, China
²BO-PE from Guangdong Decro Film New Materials co., ltd., Foshan, Guangdong, China
³Blown PE from Huangshan Novel Co., Ltd., Huangshan, Anhui, China
⁴The total thickness comprises thickness of all PE layers and thickness of adhesive between PE layers.

The drop test was conducted according to Test 1. 30 pcs of pouches prepared as above were subject to the drop test under room temperature. The tolerable height was calculated by the average of maximum height minus 3 standard deviation for total 30 pcs. The results of the drop test are shown in Table 8 below, in which the spouted stand-up pouches made of Laminates 1 and 2 both can pass the drop test both at room temperature and 5° C. This is totally unexpected because there are no known spouted stand-up pouches made of mono-PE laminate which can pass drop test.

TABLE 8
Results of the drop test

| | Tolerable height |
|---|---|
| Laminate 2 (1.35 kg pouch) | >182.0 cm |
| Laminate 3 (1.35 kg pouch) | >182.0 cm |
| Laminate 2 (500 g pouch) | >182.0 cm |
| Laminate 3 (500 g pouch) | >182.0 cm |

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A container comprising a laminate comprising:
i) a first layer of machine direction oriented polyethylene,
ii) a second layer of biaxial oriented polyethylene, and
iii) a third layer of polyethylene.

2. The container according to claim 1, wherein the total thickness of the laminate is from 70 microns to 400 microns; and or
wherein the first layer has a thickness of from 5 microns to 50 microns; and or
wherein the second layer has a thickness of from 5 microns to 50 microns; and or
wherein the third layer has a thickness of from 10 microns to 250 microns.

3. The container according to claim 1, wherein said laminate comprises no more than 10% by weight thermoplastic polymer that is not polyethylene.

4. The container according to claim 1, wherein said laminate has a tensile strength along the machine direction as measured by the method according to Test 2 of more than 100 N/inch; and or
wherein said laminate has a tensile strength along the transverse direction as measured by the method according to Test 2 of more than 100 N/inch; and or
wherein said laminate has a sealing strength at the side seal as measured by the method according to Test 3 of more than 70 N/inch; and or
wherein said laminate has a sealing strength at the bottom seal as measured by the method according to Test 3 of more than 70 N/inch.

5. The container according to claim 1, wherein said container is a flexible bag.

6. The container according to claim 1, wherein said container contains from 0.05 kg to 10 kg of product.

7. The container according to claim 6, wherein said product is selected from the group of fabric care products, home care products, hair care products, beauty care products, and personal care products.

8. The container according to claim 1, wherein the layers in said laminate are arranged as being i), ii), and iii) or ii), i) and iii) in turn from outside to inside.

9. The container according to claim 1, wherein said first layer has an initial sealing temperature of at least 130° C. as measured by the method according to Test 4; and wherein said laminate has an initial sealing temperature of no more than 125° C., as measured by the method according to Test 4.

10. A laundry detergent bag containing from 0.1 kg to 5 kg of laundry detergent, wherein the bag is constructed from a laminate comprising:
i) a first layer of machine direction oriented-polyethylene,
ii) a second layer of biaxial oriented-polyethylene, and
iii) a third layer of polyethylene.

11. The laundry detergent bag according to claim 10, wherein the total thickness of the laminate is from 70 microns to 400 microns; and or
wherein the first layer has a thickness of from 5 microns to 50 microns; and or
wherein the second layer has a thickness of from 5 microns to 50 microns; and or
wherein the third layer has a thickness of from 10 microns to 250 microns.

12. The laundry detergent bag according to claim 10, wherein said laminate has a tensile strength along the machine direction as measured by the method according to Test 2 of more than 100 N/inch; and or
wherein said laminate has a tensile strength along the transverse direction as measured by the method according to Test 2 of more than 100 N/inch; and or
wherein said laminate has a sealing strength at the side seal as measured by the method according to Test 3 of more than 70 N/inch; and or
wherein said laminate has a sealing strength at the bottom seal as measured by the method according to Test 3 of more than 70 N/inch.

13. The laundry detergent bag according to claim 10, wherein said bag is a stand-up bag with a spout.

14. A laminate comprising:
i) a first layer of machine direction oriented-polyethylene,
ii) a second layer of biaxial oriented-polyethylene, and
iii) a third layer of polyethylene.

15. The laminate according to claim 14, wherein the total thickness of the laminate is from 70 microns to 400 microns; and or
wherein the first layer has a thickness of from 5 microns to 50 microns; and or
wherein the second layer has a thickness of from 5 microns to 50 microns; and or
wherein the third layer has a thickness of from 10 microns to 250 microns.

16. The laminate according to claim 13, wherein said laminate has a tensile strength along the machine direction as measured by the method according to Test 2 of more than 100 N/inch; and or
wherein said laminate has a tensile strength along the transverse direction as measured by the method according to Test 2 of more than 100 N/inch; and or
wherein said laminate has a sealing strength at the side seal as measured by the method according to Test 3 of more than 70 N/inch; and or
wherein said laminate has a sealing strength at the bottom seal as measured by the method according to Test 3 of more than 70 N/inch.
